(19) United States
(12) Patent Application Publication
(10) Pub. No.: US 2021/0102541 A1
(43) Pub. Date: Apr. 8, 2021

(54) Wireless Fluid Circulation System

(71) Applicants: David D'Aquin, Slidell, LA (US); Don Edvalson, Slidell, LA (US)

(72) Inventors: David D'Aquin, Slidell, LA (US); Don Edvalson, Slidell, LA (US)

(21) Appl. No.: 16/596,400

(22) Filed: Oct. 8, 2019

(51) Int. Cl. F04D 13/02; A01K 63/04; H02J 50/10

(52) U.S. Cl. CPC F04D 13/027; H02J 50/10; A01K 63/047

(57) ABSTRACT

The present invention provides a fluid circulation system generally comprising a transmitter for wirelessly transmitting electrical energy through the wall of an aquarium or other container, and a receiver for receiving the electrical energy and transmitting it to a drive assembly, which circulates the water or other fluid throughout the aquarium, through the use of either a propeller or impeller.

### FIELD OF THE INVENTION

The present invention relates to pumps and other systems used to circulate fluid within a container. More particularly, the present invention provides a system for circulating water in an aquarium and the like that uses wireless energy transfer to provide power to drive the pump.

### BACKGROUND

Aquariums are a popular and widespread means of keeping and displaying fish and other aquatic plants and creatures, whether as pets, as an engaging hobby, or as colorful art. Aquariums can range in size from small glass bowls to complex structures holding millions of gallons of water, and can feature either fresh or salt water to support a wide variety of aquatic life. One common requirement of all aquariums is the need to clean and oxygenate the water if the fish or other aquatic organisms are to survive for an extended period of time. The most efficient method of accomplishing this requirement is to circulate the water by means of a pump assembly. Water movement and circulation serves to oxygenate the water, and cleaning can be accomplished by circulating the water over or through either a natural or synthetic filter medium.

An inherent problem faced by aquarists is the need to connect such pumps to a power source. Safety concerns typically prohibit the use of fully submersible electrical pumps, often resulting in an exposed pump or complex and unsightly plumbing, detracting from the aesthetic appearance of the aquarium. Even pumps that are sealed to allow full submersion require some sort of power cord, which is typically draped over the side of the aquarium.

Wireless pumps are known in the art, but they generally consist of a motor on the outside of the tank, driving a magnet on the outside of the tank, which is magnetically coupled with a magnet inside of the tank, which then turns an impeller or propeller in order to circulate the water. For example:

U.S. Pat. Nos. 10,077,775 and 9,551,343, by Marks, et al., disclose a fluid pump assembly with a pair of magnetically coupled units, wherein the first unit contains a drive motor and a magnetic assembly, the second unit contains a magnetic assembly and a propeller/impeller for imparting movement to a fluid, and as the first unit is activated by the drive motor, the resulting magnetic flux rotates the magnetic assembly in the second unit, thereby driving the propeller/impeller; and,

U.S. Pat. Nos. 10,047,750, 9,140,264, 8,734,134, 8,197,232, 7,785,081, and 7,393,188, by Lawyer, et al., disclose a fluid pump kit that includes a magnetic driven member for coupling with and rotating a propeller, a magnetic driver for magnetically coupling with and driving the magnetic driven member, and a motor to operate the magnetic driver;

However, there are multiple drawbacks inherent in these designs, such as the need for a multiplicity of moving parts, the need to precisely align the inner and outer assemblies, and the need for a bulky and relatively heavy electric motor assembly.

Wireless power transmission technology is also known in the art. For example:

U.S. Patent Application No. 2019/0230906, by Choi, et al., discloses an aquarium with wireless lighting that uses wireless power transmission technology to provide power to devices such as underwater lights, a repeater, a thermostat, a bubble generator, a pump, or a controller.

In the Choi invention, however, the power transmitter occupies the entire bottom or lateral side of the aquarium, which is bulky, interferes with plants, decorations, or other objects that may be located within the aquarium, and restricts the ease of relocating the described devices to other areas of the aquarium.

Therefore, a need exists in the field for a fluid circulation system that is compact, lightweight, and easy to install, with minimal internal moving parts, that can be powered without the need for an electrical motor or additional external moving parts, and can easily be relocated within the aquarium without affecting plants, decorations, or other objects within the aquarium.

### BRIEF SUMMARY OF THE INVENTION

The preferred embodiment of the present invention solves the aforementioned problems in a straightforward and simple manner by providing a novel system for circulating a fluid, such as water in an aquarium, through the use of a transmitter located on the outside of an aquarium to wirelessly transmit electrical energy to a receiver located inside of the tank. The receiver then supplies power to a drive mechanism to turn a shaft which is connected to a propeller, which in turn circulates the water in the aquarium. The drive unit and propeller assembly are housed together in an assembly having a rounded base that is magnetically attached to the receiver unit, which has a concave face to accept the base of the drive assembly to facilitate directing the circulation of water throughout the tank. The receiver unit is likewise held in place against a side of the aquarium by the attraction between magnets integrally located around the perimeter of the receiver housing on the inside of the tank and magnets integrally located around the perimeter of the transmitter housing on the outside of the tank. Thus, the system can be mounted to the aquarium without brackets or other mechanical means, and it can be easily located at any position on the aquarium.

An additional embodiment of the wireless circulation system incorporates the same means of wirelessly transmitting electrical energy from a transmitter located outside of the aquarium to a receiver located inside of the aquarium, which then powers a drive unit to turn linearly situated impellers, which in turn circulate water throughout the tank.

### BRIEF DESCRIPTION OF THE DRAWING

For a further understanding of the nature and objects of the present invention, reference should be had to the following description taken in conjunction with the accompanying drawing in which like parts are given like reference numerals, and wherein:

FIG. 1 depicts a block diagram of the preferred embodiment of the wireless fluid circulation system.

FIG. 2 depicts a rear-perspective view of the preferred embodiment of the wireless fluid circulation system from the transmitter side.

FIG. 3 depicts a side view of the preferred embodiment of the wireless fluid circulation system in an installed configuration.

FIG. 4 depicts a front-perspective view of the preferred embodiment of the wireless fluid circulation system.

FIG. 5 depicts a side view of the preferred embodiment of the wireless fluid circulation system showing the rounded base of the drive unit magnetically attached to the concave face of the transmitter.

FIG. 6 depicts a side view of the preferred embodiment of the wireless fluid circulation system in an installed configuration showing the directed flow capability.

FIG. 7 depicts a front-perspective of an alternate embodiment of the wireless fluid circulation system with linearly situated impellers.

### DETAILED DESCRIPTION OF THE INVENTION

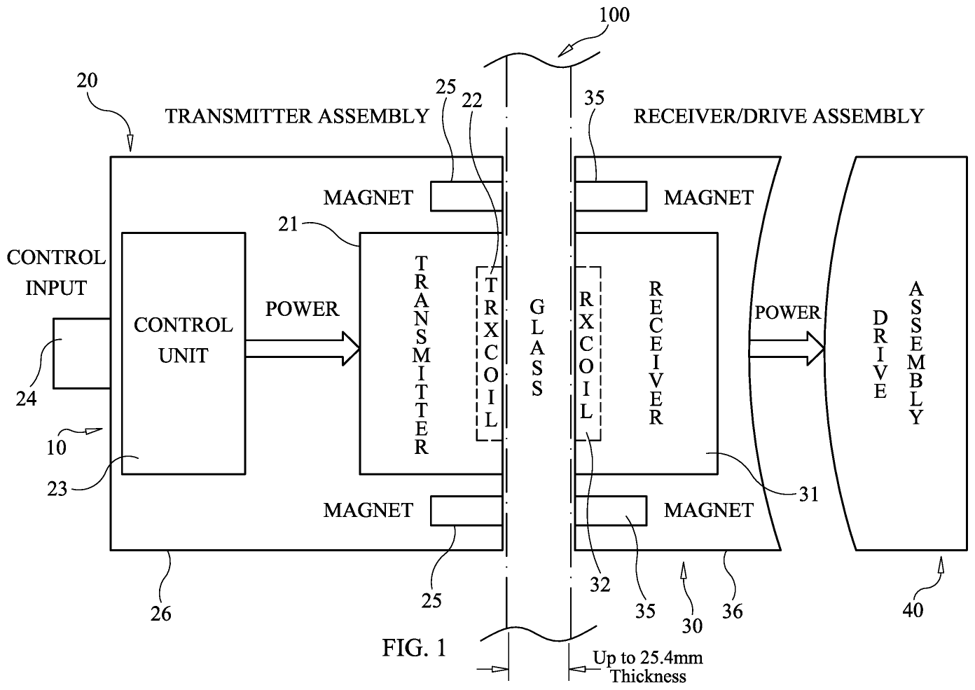

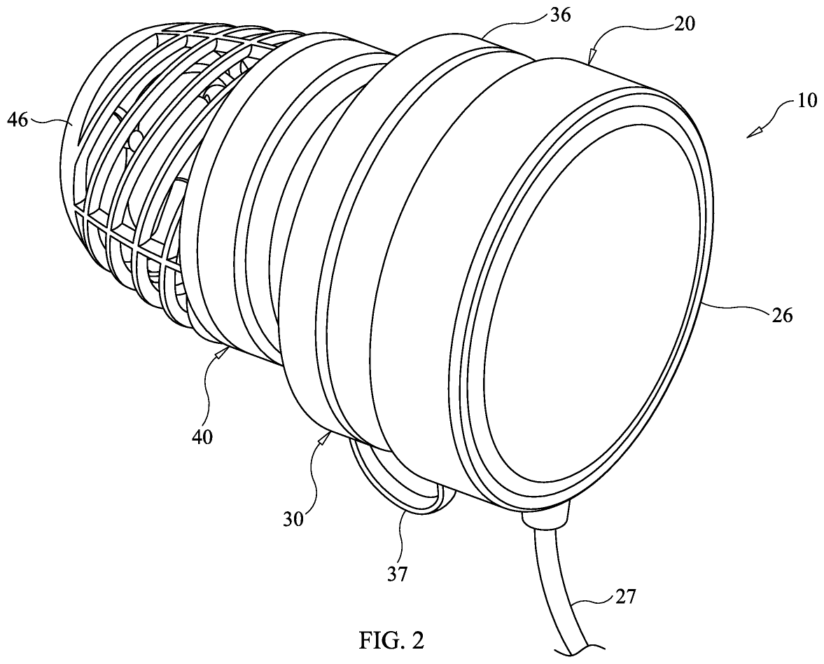

Referring now to the drawing, and in particular FIGS. 1, 2, and 3, the wireless fluid circulation system of the present invention is designated generally by the numeral 10. Wireless fluid circulation system 10 comprises transmitter assembly 20, receiver assembly 30, and drive assembly 40.

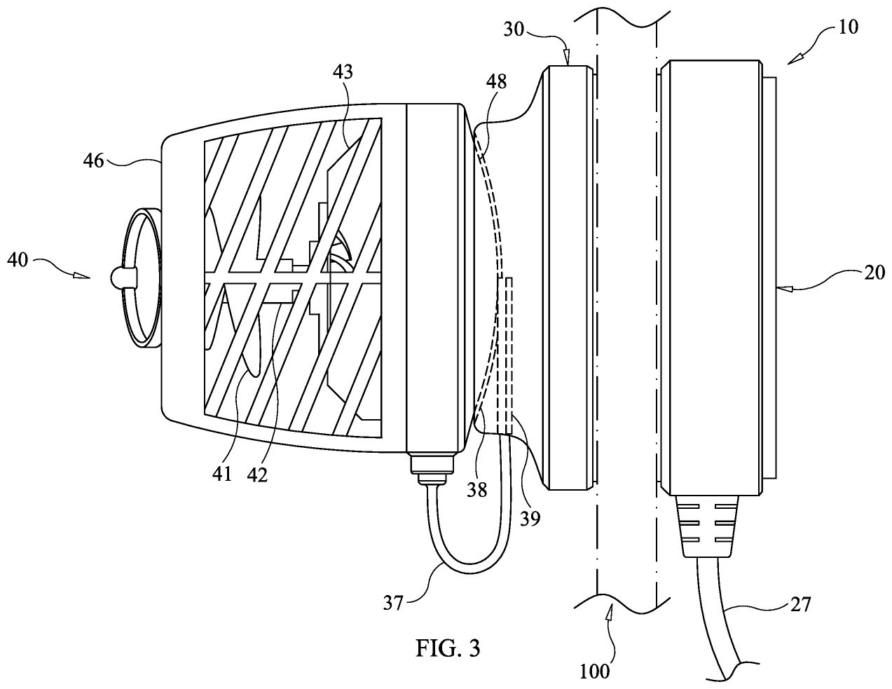

Referring now to FIGS. 1 and 3, transmitter assembly 20 further comprises wireless energy transmitter 21, transmission coil 22, control unit 23, control input 24, magnets 25, housing 26, and power cord 27. Transmitter 21, transmission coil 22, control unit 23, control input 24, and magnets 25 are contained within housing 26. Housing 26 is cylindrical, having at least one flat face, adapted to be placed against aquarium glass 100, with transmission coil 22 situated on said flat face of housing 26 and magnets 25 situated around the perimeter of housing 26. Power cord 27 is internally connected to control unit 23, and extends out of housing 26.

Receiver assembly 30 further comprises receiver 31, receiver coil 32, magnets 35, housing 36, and power cord 37. Receiver 31, receiver coil 32, and magnets 35 are contained within housing 36. Housing 36 is cylindrical, having one flat face, adapted to be placed against aquarium glass 100, and one concave face 38, which is adapted to receive the rounded base 48 of drive housing 46. Concave face 38 and rounded base 48 are constructed of magnetic material to facilitate a magnetic attraction between concave face 38 and rounded base 48 so that rounded base 48 is magnetically attached to concave face 38. Receiver coil 32 is situated on said flat face of housing 36 and magnets 35 are situated around the perimeter of housing 36. Power cord 37 is internally connected to receiver 31, extending out of housing 36 through the center of concave face 38 by means of a watertight connection, and into the bottom of drive housing 46 by means of a watertight connection, where it is internally connected to drive unit 43. Recessed channel 39 is incorporated into receiver housing 36 to accommodate storage of power cord 37.

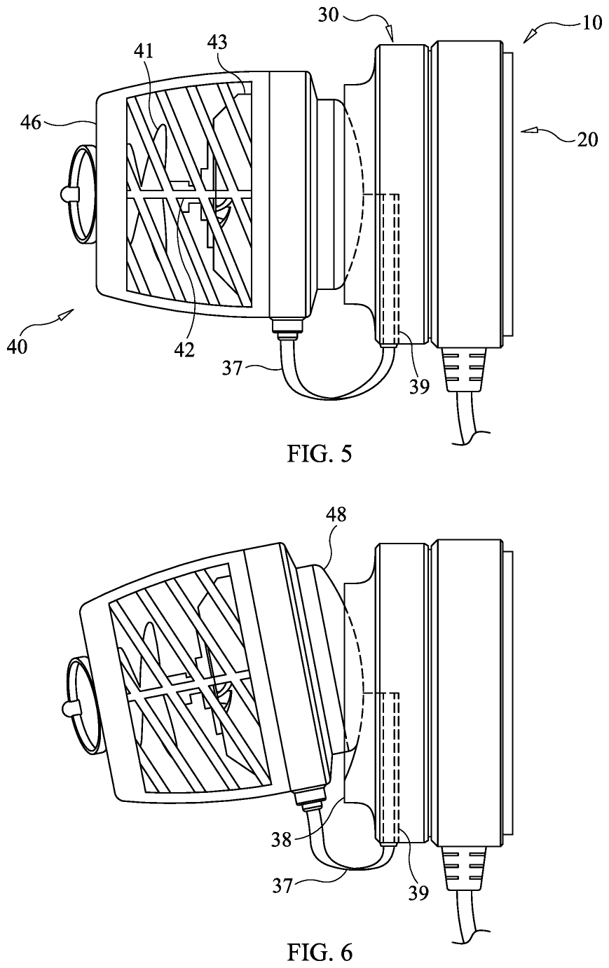

Referring now to FIGS. 3 and 5, drive assembly 40 further comprises propeller 41, shaft 42, drive unit 43, and housing 46. Drive housing 46 is a cage design to allow for efficient fluid flow, with drive unit 43, shaft 42, and propeller 41 mounted inside of the cage, such that drive unit 43 is mounted at the base of drive housing 46, with shaft 42 and propeller 41 extending longitudinally into drive housing 46 from drive unit 43.

Wireless fluid circulation system 10 is installed on an aquarium or other fluid container having a maximum wall thickness of twenty-five and four tenths millimeters by placing the flat face of transmitter housing 26 against the outside of the container wall 100, placing the flat face of receiver housing 36 against the inside of the container wall 100, and aligning transmitter assembly 20 with receiver assembly 30 so that magnets 25 magnetically engage with magnets 35. Wireless fluid circulation system 10 is held in place by the magnetic force between magnets 25 and magnets 35.

Operation of the system is achieved by applying electrical power to control unit 23 through power cord 27. Power output of control unit 23 is adjusted through control input 24, which can be actuated through manual means or remotely through infrared, radio frequency, cellular signal, wireless networking, or other remote control technology as is known in the art. Control unit 23 then transmits the adjusted power output to transmitter 21 and transmitter coil 22. Transmitter coil 22 wirelessly transmits the desired electrical energy through magnetic inductance to receiver coil 32, which is directed by receiver 31 to driver 43 by means of power cord 37. Driver 43 is of a type known in the art, which turns shaft 42, thereby turning propeller 41, causing the fluid to circulate.

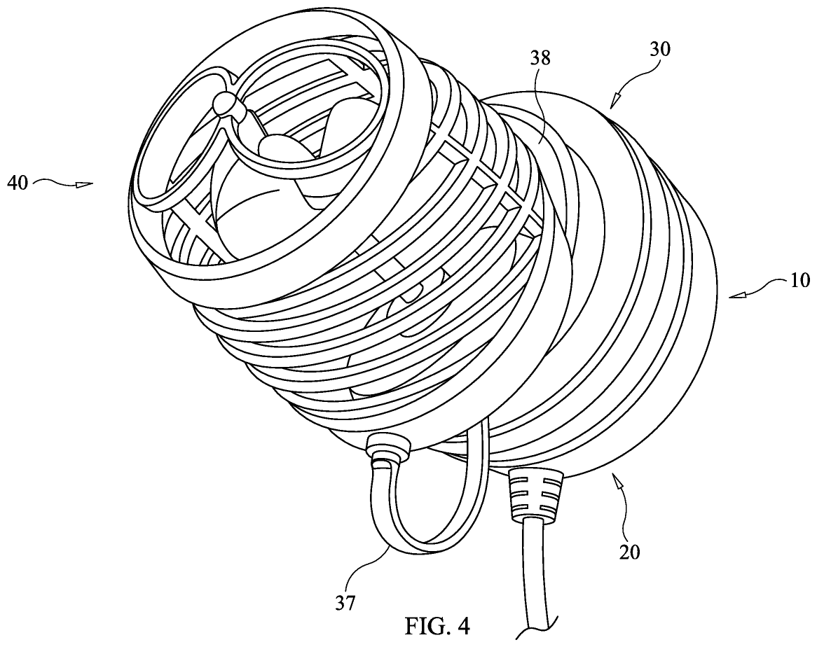

Referring now to FIGS. 4 and 6, drive assembly 40 may be rotated about rounded base 48 to direct the fluid circulation in a desired direction.

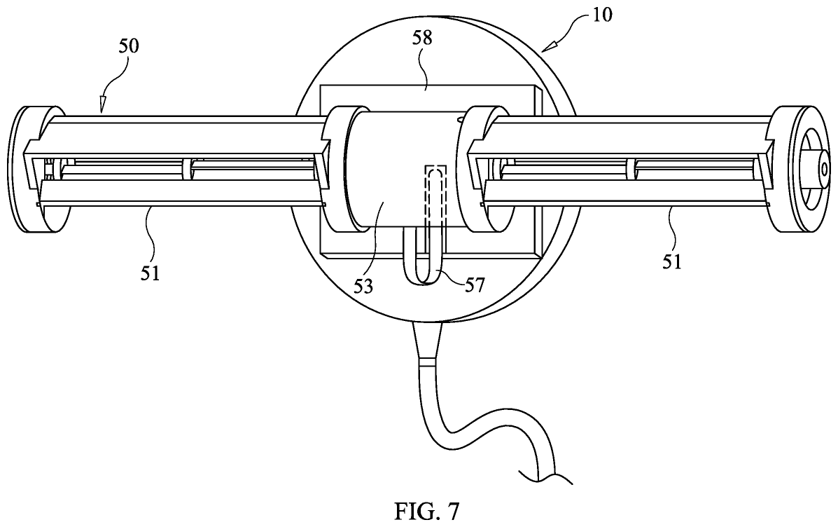

Referring now to FIG. 7, an alternate embodiment of the wireless fluid circulation system comprises impeller assembly 50, whereby transmitter assembly 10 provides electrical energy wirelessly to rectangular receiver assembly 58, which in turn provides power to drive assembly 50 through power cord 57. Power cord 57 connects receiver assembly 58 to linear drive unit 53, which turns two linearly situated impeller assemblies 51 located at opposite sides of linear drive unit 53 along a horizontal axis.

Because many varying and differing embodiments may be made within the scope of the inventive concept herein taught and because many modifications may be made in the embodiment herein detailed in accordance with the descriptive requirement of the law, it is to be understood that the details herein are to be interpreted as illustrative and not in a limiting sense.

What is claimed as invention is:

1. A wireless fluid circulation system comprising a transmitter assembly, a receiver assembly, and a drive assembly, wherein said transmitter assembly is located on the outside surface of a fluid container, said receiver assembly is located on the inside surface of a fluid container, and said transmitter assembly wirelessly transmits electrical energy to said receiver assembly, which in turn provides power to said drive assembly, which in turn circulates the fluid in the container by means of a propeller.

2. The wireless fluid circulation system of claim 1, wherein said transmitter assembly and receiver assembly are held in place by integral magnets.

3. The wireless fluid circulation system of claim 1, wherein said receiver assembly comprises a concave mount, and said drive assembly comprises a rounded base, wherein said concave mount and said rounded base are held together by magnetic attraction, which allows the drive assembly to direct the fluid circulation in a multitude of directions, and wherein said concave mount incorporates a recessed channel for storage of a power cord connecting the receiver assembly to the drive assembly.

4. The wireless fluid circulation system of claim 1, wherein said transmitter assembly includes a control input device, a control unit, a transmitter, and a transmitter coil, wherein the control input device and control unit may be used to vary the amount of power supplied to the transmitter and transmitter coil.

5. The wireless fluid circulation system of claim 4, wherein said control input device uses radio frequency technology to vary the amount of power supplied to the transmitter and transmitter coil.

6. The wireless fluid circulation system of claim 4, wherein said control input device uses wireless networking technology to vary the amount of power supplied to the transmitter and transmitter coil.

7. The wireless fluid circulation system of claim 4, wherein said control input device uses cellular device technology to vary the amount of power supplied to the transmitter and transmitter coil.

8. The wireless fluid circulation system of claim 1, wherein said drive assembly comprises a drive unit, a shaft, and one or more impellers, which circulate the fluid throughout the container.

9. The wireless fluid circulation system of claim 1, wherein said drive assembly comprises a drive unit, a shaft, and a propeller, which circulates the fluid throughout the container.

10. A wireless fluid circulation system comprising a transmitter assembly, a receiver assembly, and a drive assembly, wherein said transmitter assembly is located on the outside surface of a fluid container, said receiver assembly is located on the inside surface of a fluid container, with said transmitter assembly and said receiver assembly aligned and held in place by integral magnets, and said transmitter assembly wirelessly transmits electrical energy to said receiver assembly, which in turn provides power to said drive assembly, which in turn circulates the fluid in the container by means of a propeller, and said transmitter assembly includes a control input device, a control unit, a transmitter, and a transmitter coil, wherein the control input device and control unit may be used to vary the amount of power supplied to the transmitter and transmitter coil.

11. The wireless fluid circulation system of claim 10, wherein said control input device uses radio frequency technology to vary the amount of power supplied to the transmitter and transmitter coil.

12. The wireless fluid circulation system of claim 10, wherein said control input device uses wireless networking technology to vary the amount of power supplied to the transmitter and transmitter coil.

13. The wireless fluid circulation system of claim 10, wherein said control input device uses cellular device technology to vary the amount of power supplied to the transmitter and transmitter coil.

14. The wireless fluid circulation system of claim 10, wherein said drive assembly comprises a driver, a shaft, and a propeller, which circulates the fluid throughout the container.

15. The wireless fluid circulation system of claim 10, wherein said drive assembly comprises a driver, and two linearly situated impellers, which circulate the fluid throughout the container.

16. The wireless fluid circulation system of claim 10, wherein said receiver assembly comprises a concave mount, and said drive assembly comprises a rounded base, wherein said concave mount and said rounded base are held together by magnetic attraction, which allows the drive assembly to direct the fluid circulation in a multitude of directions, and wherein said concave mount incorporates a recessed channel for storage of the power cord connecting the receiver assembly to the drive assembly.

17. A wireless fluid circulation system comprising a transmitter assembly, a receiver assembly, and a drive assembly, wherein said transmitter assembly is located on the outside surface of a fluid container, said receiver assembly is located on the inside surface of a fluid container, with said transmitter assembly and said receiver assembly aligned and held in place by integral magnets, and said transmitter assembly wirelessly transmits electrical energy to said receiver assembly, which in turn provides power to said drive assembly, which in turn circulates the fluid in the container, said transmitter further includes a control input device, a control unit, a transmitter, and a transmitter coil, wherein the control input device and control unit may be used to vary the amount of power supplied to the transmitter and transmitter coil, said drive assembly comprises a drive unit, a shaft, and a propeller, which circulates the fluid throughout the container, and said receiver assembly comprises a concave mount, and said drive assembly comprises a rounded base, wherein said concave mount and said rounded base are held together by magnetic attraction, which allows the drive assembly to direct the fluid circulation in a multitude of directions, and wherein said concave mount incorporates a recessed channel for storage of a power cord connecting the receiver assembly to the drive assembly.

18. The wireless fluid circulation system of claim 17 wherein said control input device uses radio frequency technology to vary the amount of power supplied to the transmitter and transmitter coil.

19. The wireless fluid circulation system of claim 17 wherein said control input device uses wireless networking technology to vary the amount of power supplied to the transmitter and transmitter coil.

20. The wireless fluid circulation system of claim 17 wherein said control input device uses cellular transmission technology to vary the amount of power supplied to the transmitter and transmitter coil.
